(19) United States
(12) Patent Application Publication
(10) Pub. No.: US 2025/0369797 A1
(43) Pub. Date: Dec. 4, 2025

(54) COMBINED DE-ALIASING METHOD OF ONE-WAY WAVE EQUATION MODELING IN FREQUENCY-WAVENUMBER DOMAIN

(71) Applicant: Shanghai Institute of Technical Physics, CAS., Shanghai (CN)

(72) Inventors: Wenjun XU, Shanghai (CN); Shengli SUN, Shanghai (CN); Changqing LIN, Shanghai (CN)

(21) Appl. No.: 19/221,484

(22) Filed: May 28, 2025

(30) Foreign Application Priority Data
May 29, 2024 (CN) 202410675271.0

(51) Int. Cl. G01H 17/00; G06F 17/14

(52) U.S. Cl. CPC G01H 17/00; G06F 17/141

(57) ABSTRACT

Provided is a combined de-aliasing method of one-way wave equation modeling in a frequency-wavenumber domain. 1, nonphysical signal distortion or artificial noise resulting from a folding effect of Fourier transform and undersampling of Fourier transform and improper mathematical operations of numerical truncation or singular value generation from numerical calculation is eliminated in both of a frequency-wavenumber domain and a spatio-temporal domain; and a specific technical solution includes the following steps: step 1, eliminating singular-value aliasing; step 2, eliminating an artificial boundary noise; step 3, eliminating a Fourier folding effect; and step 4, outputting a correct one-way wave equation after eliminating the aliasing. The combined de-aliasing method of one-way wave equation modeling in a frequency-wavenumber domain involves a reasonable denoising technique, is especially aimed at a one-way wave equation modeling equation in an acoustic medium, and can be extended to elastic mediums and viscoelastic mediums.

### CROSS REFERENCE TO RELATED APPLICATION

This application claims the benefit of and priority to Chinese Patent Application No. 202410675271.0, filed on May 29, 2024, which is incorporated by reference herein in its entirety.

### TECHNICAL FIELD

The present disclosure relates to the technical field of acoustic wave processing, and in particular, to a combined de-aliasing method of one-way wave equation modeling in a frequency-wavenumber domain.

### BACKGROUND

Aliasing will be introduced in numerical calculation in the frequency-wavenumber domain. This is because nonphysical signal distortion or artificial noise results from mathematical improper operations such as the folding effect of the Fourier transform, undersampling, numerical truncation, or singular value generation from numerical calculation when a numerical signal is reconstructed in two domains. A wave field snapshot set is a three-dimensional data volume d_{wavefield} (nz, nx, nt) which is displayed in a two-dimensional format d_{wfd}_2d (nz, nsnap=nx×nt). Since filtering or de-aliasing processing is not taken into account in the wave field, a plurality of noises are generated in the whole wave field.

The strong energy of these artificial noises affects the amplitude property of the effective seismic wave front. When the wave field with aliasing is applied to deviation, due to mutual interference of multi-shot multiple gathers, the three types of aliasing can be partly suppressed with no significant influence on the deviation result. When the wave field with aliasing is applied to inversion sensitive to amplitude information, it may directly cause the inversion method to fail. Thus, aliasing type identification in one-way wave equation modeling in the frequency-wavenumber domain and the use of a reasonable denoising technique are keys to guarantee whether the one-way wave technique is successful.

### SUMMARY

The present disclosure provides a combined de-aliasing method of one-way wave equation modeling in a frequency-wavenumber domain to solve the technical problems of three types of aliasing, i.e., singular-value aliasing, Fourier folding effect, and boundary noise, mentioned in the background.

To achieve the above objective, the present disclosure adopts the following technical solutions:

Provided is a combined de-aliasing method of one-way wave equation modeling in a frequency-wavenumber domain. Nonphysical signal distortion or artificial noise resulting from a folding effect and undersampling of Fourier transform and improper mathematical operations of numerical truncation or singular value generation from numerical calculation is eliminated in both of a frequency-wavenumber domain and a spatio-temporal domain; and a specific technical solution includes the following steps:
step 1, eliminating singular-value aliasing;
step 2, eliminating an artificial boundary noise;
step 3, eliminating a Fourier folding effect; and
step 4, outputting a correct one-way wave equation after eliminating the aliasing.

In a preferred solution, step 1 may specifically include the following steps:
S1-A, eliminating a complex number frequency of a source wavelet;
S1-A1, replacing a real number frequency f in a frequency-domain wavelet

$$S ( f ) = \frac{2}{\sqrt{π} {f}_{0}} {( \frac{f}{{f}_{0}} )}^{2} {e}^{- {( \frac{f}{{f}_{0}} )}^{2}}$$

with a complex number f+idf, where

$$df = \frac{1}{T} ,$$

and a frequency-domain complex frequency wavelet is expressed as:

$$S ( f + idf ) = \frac{2}{\sqrt{π} {f}_{0}} {( \frac{f + idf}{{f}_{0}} )}^{2} {e}^{- {( \frac{f + idf}{{f}_{0}} )}^{2}} ; \qquad ( 1 )$$

S1-A2, performing inverse Fourier transformation on formula (1) to obtain formula (2):

$${F}^{- 1} \{ S ( f + idf ) \} = \int \frac{2}{\sqrt{π} {f}_{0}} {( \frac{f + idf}{{f}_{0}} )}^{2} {e}^{- {( \frac{f + idf}{{f}_{0}} )}^{2}} {e}^{i 2 π ft} df = \int \frac{2}{\sqrt{π} {f}_{0}} {( \frac{f + idf}{{f}_{0}} )}^{2} {e}^{- {( \frac{f + idf}{{f}_{0}} )}^{2}} {e}^{i 2 π ( f + idf ) t} {e}^{- 2 π dft} d ( f + idf ) = {e}^{- 2 π dft} \int \frac{2}{\sqrt{π} {f}_{0}} {( \frac{f + idf}{{f}_{0}} )}^{2} {e}^{- {( \frac{f + idf}{{f}_{0}} )}^{2}} {e}^{i 2 π ( f + idf ) t} d ( f + idf ) = {e}^{- 2 π dft} {F}^{- 1} \{ S ( f ) \} = {e}^{- 2 π dft} s ( t )$$

S1-A3, performing one-way wave operator extrapolation with the frequency-domain complex frequency wavelet of formula (2) as a wave field source function to obtain a frequency-wavenumber domain wave field value d_{wf}(k_{z}, kₓ, ω), where kₓ∈[kₓₘᵢₙ, kₓₘₐₓ], k_{z}∈[k_{zmin}, k_{zmax}], e^{-2πdft} is a transformation function, and an inverse transformation function is e^{2πdft}.

In a preferred solution, step 2 may specifically include the following steps:
S2-A, eliminating a frequency-wavenumber domain boundary noise;
S2-A1, when kₓ∈(−∞, kₓₘᵢₙ), defining a frequency-wavenumber domain wave field as:

$${d}_{wf} ( {k}_{z} , {k}_{x} , ω ) = {d}_{wf} ( {k}_{z} , {k}_{x} , ω ) * {e}^{- {a}^{2} {\vert {k}_{x} - {k}_{xmin} \vert}^{2}} ;$$

S2-A2, when kₓ∈(kₓₘₐₓ, +∞), defining the frequency-wavenumber domain wave field as:

$${d}_{wf} ( {k}_{z} , {k}_{x} , ω ) = {d}_{wf} ( {k}_{z} , {k}_{x} , ω ) * {e}^{- {a}^{2} {\vert {k}_{x} - {k}_{xmax} \vert}^{2}} ;$$

S2-A3, when k_{z}∈(−∞, k_{zmin}), defining the frequency-wavenumber domain wave field as:

$${d}_{wf} ( {k}_{𝓏} , {k}_{x} , ω ) = {d}_{wf} ( {k}_{𝓏} , {k}_{x} , ω ) * {e}^{- {b}^{2} {\vert {k}_{𝓏} - {k}_{𝓏 min} \vert}^{2}} ;$$

and
S2-A4, when k_{z}∈(k_{zmax}, +∞), defining the frequency-wavenumber domain wave field as:

$${d}_{wf} ( {k}_{𝓏} , {k}_{x} , ω ) = {d}_{wf} ( {k}_{𝓏} , {k}_{x} , ω ) * {e}^{- {a}^{2} {\vert {k}_{𝓏} - {k}_{𝓏 max} \vert}^{2}} ;$$

and
S2-B, eliminating a spatio-temporal domain artificial boundary noise;
S2-B1, when x∈(−∞, xₘᵢₙ), defining a spatio-temporal domain wave field as:

$${d}_{wf} ( 𝓏 , x , t ) = {d}_{wf} ( 𝓏 , x , t ) * {e}^{- {a}^{2} {\vert x - {x}_{min} \vert}^{2}} ;$$

S2-B2, when x∈(xₘₐₓ, +∞), defining the spatio-temporal domain wave field as:

$${d}_{wf} ( 𝓏 , x , t ) = {d}_{wf} ( 𝓏 , x , t ) * {e}^{- {a}^{2} {\vert x - {x}_{max} \vert}^{2}} ;$$

S2-B3, when z∈(−∞, zₘᵢₙ), defining the spatio-temporal domain wave field as:

$${d}_{wf} ( 𝓏 , x , t ) = {d}_{wf} ( 𝓏 , x , t ) * {e}^{- {a}^{2} {\vert 𝓏 - {𝓏}_{min} \vert}^{2}} ;$$

and
S2-B4, when z∈(zₘₐₓ, +∞), defining the spatio-temporal domain wave field as:

$${d}_{wf} ( 𝓏 , x , t ) = {d}_{wf} ( 𝓏 , x , t ) * {e}^{- {a}^{2} {\vert 𝓏 - {𝓏}_{max} \vert}^{2}} .$$

In a preferred solution, step 3 may specifically include the following steps:
S3-A, eliminating a spatio-temporal domain Fourier folding effect, and increasing a time sampling length nt to nt+mt; and
S3-B, eliminating a frequency-wavenumber domain Fourier folding effect, increasing a transverse wavenumber sampling length nkₓ to nkₓ+mkₓ, and increasing a longitudinal wavenumber sampling length nk_{z} to nk_{z}+mk_{z}.

In a preferred solution, step 4 may specifically include the following steps:
S4-A, calculating the inverse transformation function e^{2πdft} according to the Fourier transformation result of formula (2); S4-B, calculating the frequency-wavenumber domain wave field as follows:

$${d}_{wf} ( {k}_{𝓏} , {k}_{x} , ω ) = {d}_{wf} ( {k}_{𝓏} , {k}_{x} , ω ) * {e}^{2 π tdf} ;$$

and
S4-C, performing spatio-temporal domain inverse Fourier transformation to obtain a one-way wave field d_{wf}(z,x,t) after combined de-aliasing.

As can be seen from the above, according to the combined de-aliasing method of one-way wave equation modeling in a frequency-wavenumber domain, the nonphysical signal distortion or the artificial noise resulting from mathematical improper operations of the folding effect of the Fourier transform, undersampling, numerical truncation, or singular value generation from numerical calculation is eliminated in both of the frequency-wavenumber domain and the spatio-temporal domain; and the specific technical solution includes the following steps:
step 1, eliminating singular-value aliasing;
step 2, eliminating an artificial boundary noise;
step 3, eliminating a Fourier folding effect; and
step 4, outputting a correct one-way wave equation after eliminating the aliasing. The combined de-aliasing method of one-way wave equation modeling in a frequency-wavenumber domain provided in the present disclosure involves a reasonable denoising technique, is especially aimed at a one-way wave equation modeling equation in an acoustic medium, and can be extended to elastic mediums and viscoelastic mediums.

### BRIEF DESCRIPTION OF THE DRAWINGS

FIG. 1 is a flowchart 1 of a technique of combined de-aliasing for a one-way wave in a frequency-wavenumber domain in an acoustic medium according to the present disclosure.

FIG. 2 is a flowchart 2 of a technique of combined de-aliasing for a one-way wave in a frequency-wavenumber domain in an acoustic medium according to the present disclosure.

FIG. 3 is a diagram showing a generalized screen full wave field snapshot set in a constant velocity model of a technique of combined de-aliasing for a one-way wave in a frequency-wavenumber domain in an acoustic medium according to the present disclosure.

FIG. 4 is a diagram showing a certain time slice in full wave field gather data of a technique of combined de-aliasing for a one-way wave in a frequency-wavenumber domain in an acoustic medium according to the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure.

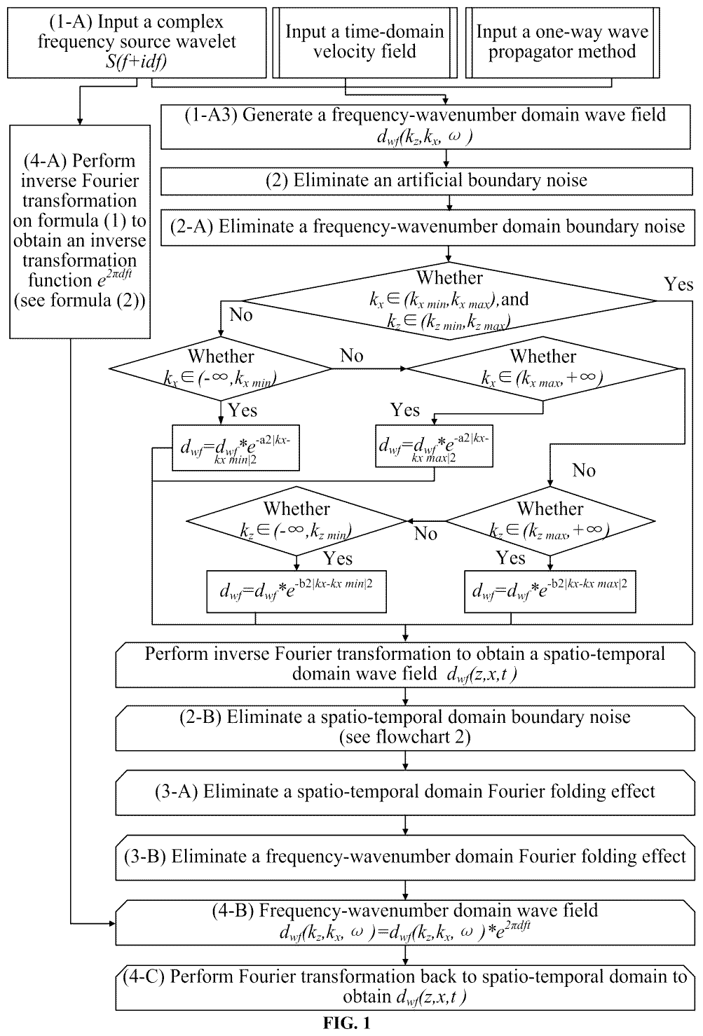

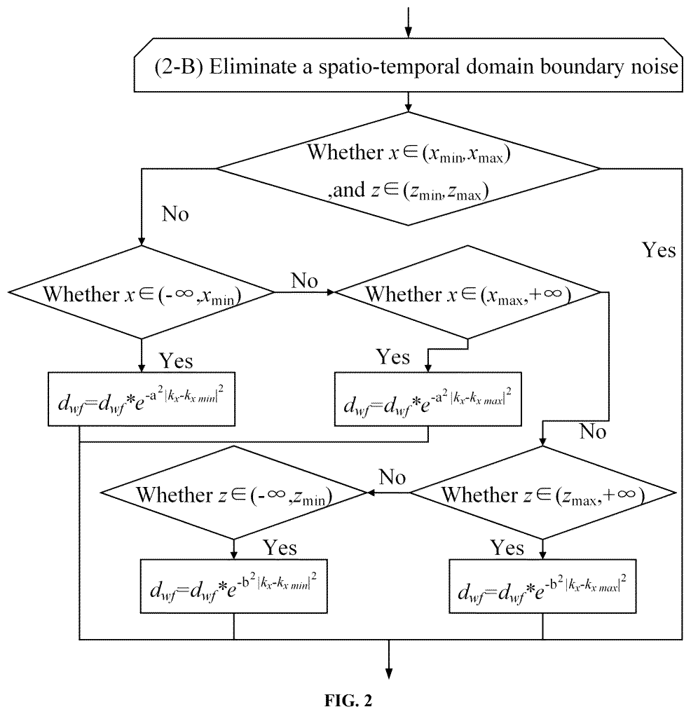

With reference to FIG. 1 to FIG. 4, a combined de-aliasing method of one-way wave equation modeling in a frequency-wavenumber domain specifically includes the following steps.

In step 1, singular-value aliasing is eliminated.

(1-A) A complex number frequency of a source wavelet is eliminated.

(1-A1) A real number frequency f in a frequency-domain wavelet

$$S ( f ) = \frac{2}{\sqrt{π} {f}_{0}} {( \frac{f}{{f}_{0}} )}^{2} {e}^{- {( \frac{f}{{f}_{0}} )}^{2}}$$

is replaced with a complex number f+idf.

(1-A2) Inverse Fourier transformation is performed on formula (1).

(1-A3) One-way wave operator extrapolation is performed with the frequency-domain complex frequency wavelet of formula (2) as a wave field source function to obtain a frequency-wavenumber domain wave field value d_{wf}(k_{z},kₓ,ω)

In step 2, an artificial boundary noise is eliminated.

(2-A) A frequency-wavenumber domain boundary noise is eliminated.

(2-A1) When kₓ∈(−∞, kₓₘᵢₙ), a frequency-wavenumber domain wave field is defined as:

$${d}_{wf} ( {k}_{𝓏} , {k}_{x} , ω ) = {d}_{wf} ( {k}_{𝓏} , {k}_{x} , ω ) * {e}^{- {a}^{2} {\vert {k}_{x} - {k}_{xmin} \vert}^{2}} .$$

(2-A2) When kₓ∈(kₓₘₐₓ, +∞), the frequency-wavenumber domain wave field is defined as:

$${d}_{wf} ( {k}_{𝓏} , {k}_{x} , ω ) = {d}_{wf} ( {k}_{𝓏} , {k}_{x} , ω ) * {e}^{- {a}^{2} {\vert {k}_{x} - {k}_{xmax} \vert}^{2}} .$$

(2-A3) When k_{z}∈(−∞, k_{zmin}), the frequency-wavenumber domain wave field is defined as:

$${d}_{wf} ( {k}_{𝓏} , {k}_{x} , ω ) = {d}_{wf} ( {k}_{𝓏} , {k}_{x} , ω ) * {e}^{- {b}^{2} {\vert {k}_{𝓏} - {k}_{𝓏 min} \vert}^{2}} .$$

(2-A4) When k_{z}∈(k_{zmax}, +∞), the frequency-wavenumber domain wave field is defined as:

$${d}_{wf} ( {k}_{𝓏} , {k}_{x} , ω ) = {d}_{wf} ( {k}_{𝓏} , {k}_{x} , ω ) * {e}^{- {a}^{2} {\vert {k}_{𝓏} - {k}_{𝓏 max} \vert}^{2}} .$$

(2-B) A spatio-temporal domain artificial boundary noise is eliminated.

(2-B1) When x∈(−∞, xₘᵢₙ), a spatio-temporal domain wave field is defined as:

$${d}_{wf} ( 𝓏 , x , t ) = {d}_{wf} ( 𝓏 , x , t ) * {e}^{- {a}^{2} {\vert x - {x}_{min} \vert}^{2}} .$$

(2-B2) When x∈(xₘₐₓ, +∞), the spatio-temporal domain wave field is defined as:

$${d}_{wf} ( 𝓏 , x , t ) = {d}_{wf} ( 𝓏 , x , t ) * {e}^{- {a}^{2} {\vert x - {x}_{max} \vert}^{2}} .$$

(2-B3) When z∈(−∞, zₘᵢₙ), the spatio-temporal domain wave field is defined as:

$${d}_{wf} ( 𝓏 , x , t ) = {d}_{wf} ( 𝓏 , x , t ) * {e}^{- {a}^{2} {\vert 𝓏 - {𝓏}_{min} \vert}^{2}} .$$

(2-B4) When z∈(zₘₐₓ, +∞), the spatio-temporal domain wave field is defined as:

$${d}_{wf} ( z , x , t ) = {d}_{wf} ( z , x , t ) * {e}^{- {a}^{2} {\vert z - {z}_{max} \vert}^{2}} .$$

In step 3, a Fourier folding effect is eliminated.

(3-A) A spatio-temporal domain Fourier folding effect is eliminated. A time sampling length nt is increased to nt+mt.

(3-B) A frequency-wavenumber domain Fourier folding effect is eliminated. A transverse wavenumber sampling length nkₓ is increased to nkₓ+mkₓ, and a longitudinal wavenumber sampling length nk_{z} is increased to nk_{z}+mk_{z}.

In step 4, a correct one-way wave equation is output after eliminating the aliasing.

(4-A) The inverse transformation function e^{2πdft} is calculated according to the Fourier transformation result of formula (2).

(4-B) The frequency-wavenumber domain wave field is calculated as follows:

$${d}_{wf} ( {k}_{z} , {k}_{x} , ω ) = {d}_{wf} ( {k}_{z} , {k}_{x} , ω ) * {e}^{2 π tdf} .$$

(4-C) Spatio-temporal domain inverse Fourier transformation is performed to obtain a one-way wave field d_{wf}(z,x,t) after combined de-aliasing.

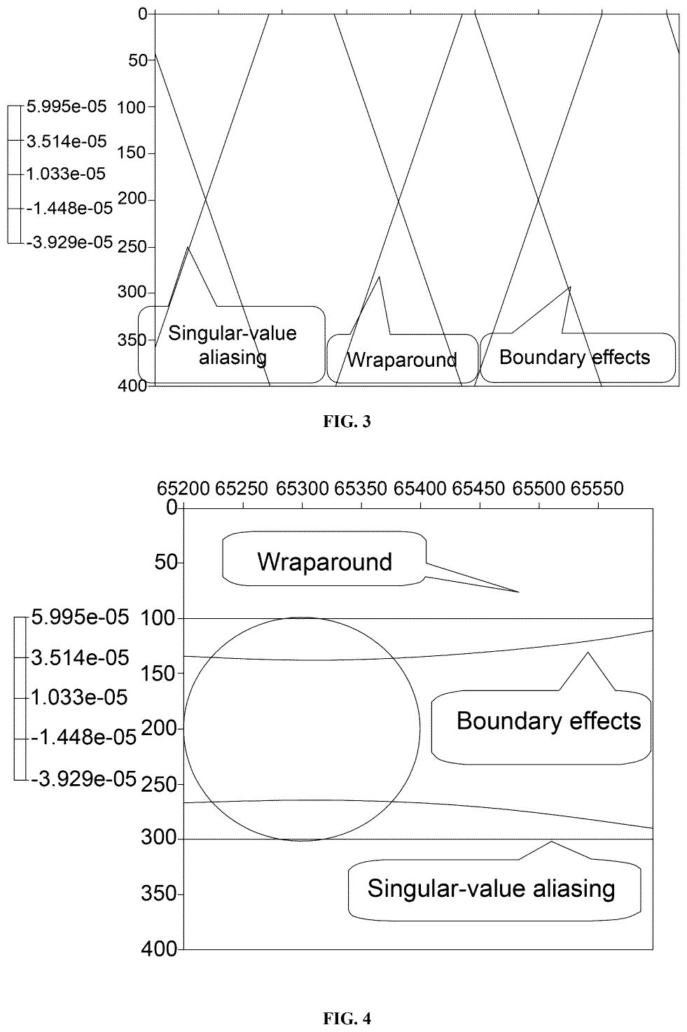

In FIG. 3, the horizontal axis shows the number of wave field snapshots, and the vertical axis shows the number of z-axis grid points. Each wave field snapshot is arranged according to an acquisition time t to form a whole wave field gather. The source function is Ricker wavelet with a center frequency of 10 hz. The whole wave field is not subjected to filtering or de-aliasing processing.

In FIG. 4, the horizontal axis shows the number of transverse sampling points on the x-axis of the model, and the vertical axis shows the number of z-axis grid points. The aliasing such as the singular-value aliasing, the Fourier folding effect, and the boundary noise is included in the figure.

The foregoing are merely descriptions of preferred specific implementations of the present disclosure, but the protection scope of the present disclosure is not limited thereto. Any equivalent replacement or modification made within the technical scope of the present disclosure by a person skilled in the art according to the technical solutions of the present disclosure and inventive concepts thereof shall fall within the protection scope of the present disclosure.

What is claimed is:

1. A combined de-aliasing method of one-way wave equation modeling in a frequency-wavenumber domain, wherein nonphysical signal distortion or artificial noise resulting from a folding effect and undersampling of Fourier transform, and improper mathematical operations of numerical truncation or singular value generation from numerical calculation is eliminated in both of a frequency-wavenumber domain and a spatio-temporal domain; and a specific technical solution comprises the following steps:
step 1, eliminating singular-value aliasing;
step 2, eliminating an artificial boundary noise;
step 3, eliminating a Fourier folding effect; and
step 4, outputting a correct one-way wave equation after eliminating the aliasing.

2. The combined de-aliasing method of one-way wave equation modeling in a frequency-wavenumber domain according to claim 1, wherein step 1 specifically comprises the following steps:
S1-A, eliminating a complex number frequency of a source wavelet;
S1-A1, replacing a real number frequency f in a frequency-domain wavelet
$$S ( f ) = \frac{2}{\sqrt{π} {f}_{0}} {( \frac{f}{{f}_{0}} )}^{2} {e}^{- {( \frac{f}{{f}_{0}} )}^{2}}$$
with a complex number f+idf, wherein
$$df = \frac{1}{T} ,$$
and a frequency-domain complex frequency wavelet is expressed as:
$$S ( f + idf ) = \frac{2}{\sqrt{π} {f}_{0}} {( \frac{f + idf}{{f}_{0}} )}^{2} {e}^{- {( \frac{f + idf}{{f}_{0}} )}^{2}} ; \qquad ( 1 )$$
S1-A2, performing inverse Fourier transformation on formula (1) to obtain formula (2):
$$\begin{matrix}{F}^{- 1} \{ S ( f + idf ) \} = \int \frac{2}{\sqrt{π} {f}_{0}} {( \frac{f + idf}{{f}_{0}} )}^{2} {e}^{- {( \frac{f + idf}{{f}_{0}} )}^{2}} {e}^{i 2 π ft} df \\ = \int \frac{2}{\sqrt{π} {f}_{0}} {( \frac{f + idf}{{f}_{0}} )}^{2} {e}^{- {( \frac{f + idf}{{f}_{0}} )}^{2}} {e}^{i 2 π ( f + idf ) t} {e}^{- 2 π dft} d ( f + idf ) \\ = {e}^{- 2 π dft} \int \frac{2}{\sqrt{π} {f}_{0}} {( \frac{f + idf}{{f}_{0}} )}^{2} {e}^{- {( \frac{f + idf}{{f}_{0}} )}^{2}} {e}^{i 2 π ( f + idf ) t} d ( f + idf ) \\ = {e}^{- 2 π dft} {F}^{- 1} \{ S ( f ) \} \\ = {e}^{- 2 π dft} s ( t )\end{matrix} ; and$$
S1-A3, performing one-way wave operator extrapolation with the frequency-domain complex frequency wavelet of formula (2) as a wave field source function to obtain a frequency-wavenumber domain wave field value d_{wf}(k_{z},kₓ,ω), wherein kₓ∈[kₓₘᵢₙ, kₓₘₐₓ], k_{z}∈[k_{zmin}, k_{zmax}], e^{-2πdft} is a transformation function, and an inverse transformation function is e^{2πdft}.

3. The combined de-aliasing method of one-way wave equation modeling in a frequency-wavenumber domain according to claim 1, wherein step 2 specifically comprises the following steps:
S2-A, eliminating a frequency-wavenumber domain boundary noise;
S2-A1, when kₓ∈(−∞, kₓₘᵢₙ), defining a frequency-wavenumber domain wave field as:
$${d}_{wf} ( {k}_{z} , {k}_{x} , ω ) = {d}_{wf} ( {k}_{z} , {k}_{x} , ω ) * {e}^{- {a}^{2} {\vert {k}_{x} - {k}_{x min} \vert}^{2}} ;$$
S2-A2, when kₓ∈(kₓₘₐₓ; +∞), defining the frequency-wavenumber domain wave field as:
$${d}_{wf} ( {k}_{z} , {k}_{x} , ω ) = {d}_{wf} ( {k}_{z} , {k}_{x} , ω ) * {e}^{- {a}^{2} {\vert {k}_{x} - {k}_{x max} \vert}^{2}} ;$$
S2-A3, when k_{z}∈(−∞, k_{zmin}), defining the frequency-wavenumber domain wave field as:
$${d}_{wf} ( {k}_{z} , {k}_{x} , ω ) = {d}_{wf} ( {k}_{z} , {k}_{x} , ω ) * {e}^{- {b}^{2} {\vert {k}_{z} - {k}_{z min} \vert}^{2}} ;$$
and
S2-A4, when k_{z}∈(k_{zmax}, +∞), defining the frequency-wavenumber domain wave field as:
$${d}_{wf} ( {k}_{z} , {k}_{x} , ω ) = {d}_{wf} ( {k}_{z} , {k}_{x} , ω ) * {e}^{- {a}^{2} {\vert {k}_{z} - {k}_{z max} \vert}^{2}} ;$$
and
S2-B, eliminating a spatio-temporal domain artificial boundary noise;
S2-B1, when x∈(−∞, xₘᵢₙ), defining a spatio-temporal domain wave field as:
$${d}_{wf} ( z , x , t ) = {d}_{wf} ( z , x , t ) * {e}^{- {a}^{2} {\vert x - {x}_{min} \vert}^{2}} ;$$
S2-B2, when x∈(xₘₐₓ, +∞), defining the spatio-temporal domain wave field as:
$${d}_{wf} ( z , x , t ) = {d}_{wf} ( z , x , t ) * {e}^{- {a}^{2} {\vert x - {x}_{max} \vert}^{2}} ;$$
S2-B3, when z∈(−∞, zₘᵢₙ), defining the spatio-temporal domain wave field as:
$${d}_{wf} ( z , x , t ) = {d}_{wf} ( z , x , t ) * {e}^{- {a}^{2} {\vert z - {z}_{min} \vert}^{2}} ;$$
and
S2-B4, when z∈(zₘₐₓ, +∞), defining the spatio-temporal domain wave field as:
$${d}_{wf} ( z , x , t ) = {d}_{wf} ( z , x , t ) * {e}^{- {a}^{2} {\vert z - {z}_{max} \vert}^{2}} .$$

4. The combined de-aliasing method of one-way wave equation modeling in a frequency-wavenumber domain according to claim 1, wherein step 3 specifically comprises the following steps:
S3-A, eliminating a spatio-temporal domain Fourier folding effect, and increasing a time sampling length nt to nt+mt; and
S3-B, eliminating a frequency-wavenumber domain Fourier folding effect, increasing a transverse wavenumber sampling length nkₓ to nkₓ+mkₓ, and increasing a longitudinal wavenumber sampling length nk_{z} to nk_{z}+mk_{z}.

5. The combined de-aliasing method of one-way wave equation modeling in a frequency-wavenumber domain according to claim 1, wherein step 4 specifically comprises the following steps:
S4-A, calculating an inverse transformation function e^{2πdft} according to a Fourier transformation result of formula (2);
S4-B, calculating a frequency-wavenumber domain wave field as follows:
$${d}_{wf} ( {k}_{z} , {k}_{x} , ω ) = {d}_{wf} ( {k}_{z} , {k}_{x} , ω ) * {e}^{2 π tdf} ;$$
and
S4-C, performing spatio-temporal domain inverse Fourier transformation to obtain a one-way wave field d_{wf}(z,x,t) after combined de-aliasing.
